(19) United States
(12) Patent Application Publication
(10) Pub. No.: US 2004/0212246 A1
(43) Pub. Date: Oct. 28, 2004

(54) Vehicle brake system for preventing brake noise

(76) Inventors: Masahiko Kamiya, Anjo-city (JP); Hiroshi Kondo, Chiryu-city (JP); Shin Sasaki, Okazaki-city (JP); Daizo Oba, Kariya-city (JP)

Correspondence Address: POSZ & BETHARDS, PLC, 11250 ROGER BACON DRIVE, SUITE 10, RESTON, VA, 20190, US

(21) Appl. No.: 10/820,027

(22) Filed: Apr. 8, 2004

(30) Foreign Application Priority Data
Apr. 24, 2003 (JP) 2003-120406

(51) Int. Cl. B60T 13/18

(52) U.S. Cl. 303/11

(57) ABSTRACT

In a case where a generation of a brake noise is detected at least one of the front and rear wheels on the left side and on the right side, respectively, the vehicle brake system selects a wheel where the generation of the brake noise is detected as a noise generating single-wheel. Then the vehicle brake system reduces target braking force for the noise generating wheel by a predetermined amount, thereby reducing or suppressing the brake noise in the noise generating wheel. At the same time, the vehicle brake system increases target braking force for one of the front and rear wheels which is other than the noise generating wheel by the amount equivalent to the predetermined amount mentioned above. Accordingly, while the deviation of the braking force from the optimal distribution between the front and the rear of the vehicle is reduced, the driver does not feel an unpleasant sensation due to an abnormal vehicle behavior and the like.

### CROSS REFERENCE TO RELATED APPLICATION

This application is based upon and claims the benefit of Japanese Patent Application No. 2003-120406 filed on Apr. 24, 2003, the content of which are incorporated herein by reference.

### FIELD OF THE INVENTION

The present invention relates to a vehicle brake system, more particularly to a vehicle brake system which reduces or suppresses a brake noise.

### BACKGROUND OF THE INVENTION

Conventionally, an apparatus which prevents a brake noise is disclosed in Japanese Patent Application Laid-Open Publication No.9-221013 and No.10-305768. In the related art, when a brake noise is detected, both braking forces applied to a left front wheel and a right rear wheel are reduced, and both braking forces applied to a left rear wheel and a right rear wheel are increased. Accordingly, while total braking force is maintained for an entire vehicle, a distribution of the braking force between the front and rear is controlled, whereby generation of brake noise is avoided.

In a vehicle, generally, a load distribution between the front and rear is taken into consideration, and an optimal distribution of braking force for front wheels and braking force for rear wheels is made, so that locking of the rear wheels is prevented on any road conditions, and a characteristic which is close to an ideal distribution of braking force is obtained which allows the braking force to be generated at the highest efficiency.

However, the related art makes a set of the left and right front wheels and a set of the left and right rear wheels. In order to reduce a brake noise, the same amount of pressurized amounts (braking force) is increased or reduced for the set of the left and right front wheels and the set of the left and right rear wheels. That is, in the related art as described above, there is a case, for example, where braking force applied to the left and right front wheels is uniformly increased and braking force applied to the left and right rear wheels is uniformly reduced. Accordingly, although the brake noise is reduced, at the same time a deviation from the optimal distribution of the braking force between the front and the rear becomes excessively large, whereby locking of the rear wheels or an abnormal behavior of the vehicle may occur. Therefore, a driver may feel an unpleasant sensation when executing a noise prevention control.

### SUMMARY OF THE INVENTION

It is an object of the present invention to prevent an abnormal vehicle behavior even if a change in braking force is provided to wheels in order to reduce a brake noise.

In a vehicle brake system according to a first aspect of the present invention, there is a case where a generation of a brake noise is detected at least one of left front and rear wheels and at least one of right front and rear wheels, respectively. In this case, the vehicle brake system selects a wheel where the generation of the brake noise is detected as a noise generating single-wheel. Then the vehicle brake system reduces target braking force for the noise generating wheel by a predetermined amount, thereby reducing or suppressing the brake noise of the noise generating wheel. At the same time, the vehicle brake system increases target braking force for the wheel of the front and rear wheels, which is other than the noise generating wheel by the same amount as mentioned above.

That is, the vehicle brake system reduces or suppresses the brake noise by controlling the braking force so as not to change the total braking force for the front and rear wheels, on one of the right side and the left side where the brake noise is generated. At the same time, the vehicle brake system does not change the braking force for the front and rear wheels on the side where the brake noise is not generated.

Accordingly, deviation of the braking force from the optimal distribution of the braking force between the front and the rear can be reduced, compared with a case where braking force for one of a set of the left and right front wheels and a set of the left and right rear wheels is increased and braking force for the other set of the wheels is reduced. Accordingly, when executing a brake control for preventing a brake noise, a driver does not feel an unpleasant sensation due to an abnormal vehicle behavior and the like.

A vehicle brake system according to a second aspect of the present invention selects a pair of diagonal wheels including a wheel where a brake noise is detected as generating diagonal wheels, and reduces braking force for both wheels that constitute the generating diagonal wheels by a predetermined amount at the same time. Accordingly, it is possible to reduce, suppress, or prevent a brake noise in each of the set of diagonal wheels including the wheel where a brake noise is generated.

Furthermore, the vehicle brake system increases the braking force for the other set of diagonal wheels that are not selected as the generating diagonal wheels by the amount equivalent to that by which the braking force for the diagonal generating wheels is reduced. Accordingly, all of the total braking force for the left front and rear wheels, the total braking force for the right front and rear wheels, the total braking force for the left and right front wheels, and the total braking force for the left and right rear wheels remain unchanged.

Therefore, deviation of the braking force from the optimal distribution of the braking force between the front and the rear of the vehicle can be reduced, and a change of the braking force in the left and right sides of the vehicle is eliminated. Accordingly, a brake noise can be reduced or suppressed and an abnormal vehicle behavior is eliminated, whereby the driver does not feel an unpleasant sensation.

Meanwhile, the left and right wheels on the same axle (that is, the left and right front wheels or the left and right rear wheels) are equally likely to generate a brake noise. Also as to these wheels on the same axle, a change in the braking force occurs in the opposite manner on the left side and the right side, thereby enabling a change in a vibration mode. Therefore, it is possible to prevent a brake noise in advance, even in the case where no brake noise is generated in the set of diagonal wheels other than the generating diagonal wheels.

### BRIEF DESCRIPTION OF THE DRAWINGS

Other objects, features and advantages of the present invention will be understood more fully from the following detailed description made with reference to the accompanying drawings. In the drawings:

FIG. 1 shows a schematic configuration of a vehicle brake system according to a first embodiment of the present invention;

FIG. 2 is a flow chart showing a procedure content of a main routine of a brake control which is executed by the ECU;

FIG. 3 is a flow chart showing a routine of a noise prevention brake control according to the first embodiment; and

FIG. 4 is a flow chart showing a routine of a noise prevention brake control according to a second embodiment of the present invention.

### DETAILED DESCRIPTION OF THE PREFERRED EMBODIMENTS

The present invention will be described further with reference to various embodiments in the drawings.

First Embodiment

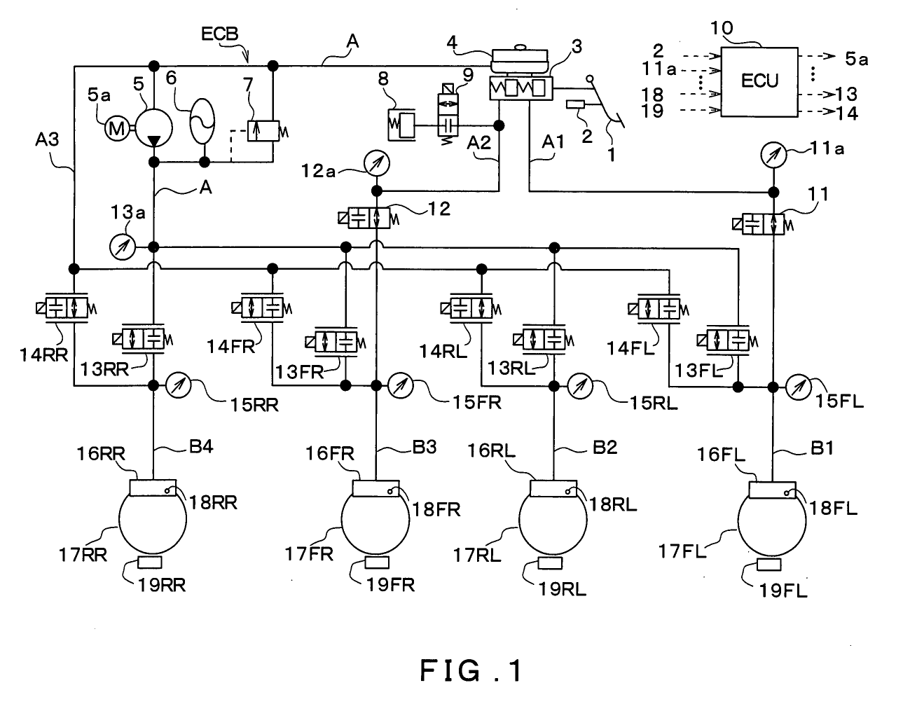

A vehicle braking system according to a first embodiment of the present invention will be explained with reference to the drawings. FIG. 1 shows a schematic configuration of the first embodiment. Note that FIG. 1 shows a state where a current is not applied to any solenoid valves when a brake is not actuated.

The vehicle braking system according to the first embodiment is provided with a brake ECU (hereinafter referred to as ECU) 10. The ECU 10 controls hydraulic pressures to be applied to calipers (hereinafter referred to as independently controlled calipers) 16FL, 16RL, 16FR, and 16RR, respectively, which are provided for each of a left front wheel FL, a right front wheel FR, a left rear wheel RL, and a right rear wheel RR, based on detection signals from various sensors, so as to independently control braking force for the four wheels.

Therefore, an explanation will be given mainly on the brake system on the left front wheel FL and the left rear wheel RL, hereafter, and an explanation on the brake system on the right front wheel FR and the right rear wheel RR will be simplified.

The master cylinder 3 generates a master cylinder pressure corresponding to a depression amount of a brake pedal 1. When an error occurs in a power supply system to be described later, the master cylinder 3 applies the master cylinder pressure to the left front wheel FL via a brake conduit A1 which is connected to one of fluid chambers of the master cylinder 3 and generates braking force. That is, the brake conduit A1 is connected from the fluid chamber of the master cylinder 3, via a master cut valve 11, to a caliper 16FL of the front left wheel FL. The master cut valve 11 is a normally open valve which is communicated when normal braking is not applied and which is shut off when normal braking is applied. When an error occurs in the brake operating state, the master cut valve 11 is communicated, and applies the master pressure to the caliper 16FL, thereby generating the braking force in the front wheels. Note that a pressure sensor 11a detects the master cylinder pressure and outputs detection signals to the ECU 10.

Further, a brake conduit A2 which is connected to the other fluid chamber of the master cylinder 3 is connected, via a master cut valve 12, to a caliper 16FR of the right front wheel FR. Further, the brake conduit A2 is communicated with a stroke simulator 8 via a simulator cut valve 9. In other words, when normal braking is applied, the simulator cut valve 9 is communicated so as to communicate the stroke simulator 8 with the master cylinder 3 and generates reaction force provided by the stroke simulator 8 in the brake pedal 1. Accordingly, when normal braking is applied, a driver is able to feel a pedal reaction force corresponding to the depression amount of the brake pedal 1. Moreover, the simulator cut valve 9 is shut off when a braking is not applied and when an error occurs in the power supply system, whereby the stroke simulator 8 is shut off from the master cylinder 3. Note that a stroke sensor 2 is disposed on the brake pedal 1. The stroke sensor 2 detects a depression amount of the brake pedal 1 and outputs the detection signal to the ECU 10.

A pump 5 is driven by a motor 5a. An intake port of the pump 5 is communicated with a reservoir 4 via a main brake conduit A. The pump 5 pumps up a brake fluid from the reservoir 4 via the main brake conduit A and discharges a high hydraulic pressure to an accumulator 6. The accumulator 6 accumulates the hydraulic pressure generated by the pump 5 and constitutes a power supply system for controlling braking. A pressure sensor 13a detects a discharge pressure of the main brake conduit A at a discharge port of the pump 5, that is, the accumulated pressure in the accumulator 6, and outputs a detection signal to the ECU 10. Note that a relief valve 7 relieves the brake fluid to the reservoir 4 when the pressure is abnormally high in the power supply system. The reservoir 4 accumulates the brake fluid for the master cylinder 3 and the power supply system.

The main brake conduit A is communicated with the first brake conduit B1 which is connected to the caliper 16FL of the front left wheel FL, and communicated with the second brake conduit B2 connected to the caliper 16RL of the rear left wheel RL, respectively. A first pressure boosting linear valve 13FL is disposed in the first brake conduit B1, and a second pressure boosting linear valve 13RL is disposed in the second brake conduit B2.

A return brake conduit A3 is connected via a first pressure reducing linear valve 14FL, which serves as a normally closed valve, to a portion between the first pressure boosting linear valve 13FL and the caliper 16FL of the front left wheel FL of the first brake conduit B1. Also, the return brake conduit A3 is connected via a second pressure reducing linear valve 14RL, which serves as a normally opened valve, to a portion between the second pressure boosting linear valve 13RL and the caliper 16FL of the front left wheel FL and the caliper 16RL of the rear left wheel RL of the second brake conduit B2. The return brake conduit A3 is communicated with the reservoir 4.

Note that the second pressure reducing linear valve 14RL is a normally open valve in order to release braking force for the rear wheel when an error occurs with the actuation of the brake, thereby preventing the rear wheels to be from being dragged.

A hydraulic pressure in the first brake conduit B1 and a hydraulic pressure in the second brake conduit B2 are detected by pressure sensors 15FL and 15RL, and detection signals are fed to the ECU 10.

Moreover, vibration sensors 18FL and 18RL are disposed in the caliper 16FL of the left front wheel FL and the caliper 16RL in the left rear wheel RL, respectively. The vibration sensors 18FL and 18RL detect vibration generated in the caliper body which is caused by the brake noise and feed detection signals to the ECU 10.

A vibration frequency which is selected ranges from some hundreds of hertz to decades of kilo hertz including a vibration accompanying a brake noise or a vibration which corresponds to a brake noise (such as from 1 kHz to 6 kHz). The detection signals from the vibration sensors 18 are fed to the ECU 10 which determines whether or not the brake noise is present and calculates a magnitude of the brake noise based on the magnitude of a vibration frequency component corresponding to the brake noise.

Further, wheel speed sensors 19 (19FL, 19RL, 19FR and 19RR) are disposed for wheels FL, RL, FR, and RR, respectively. The wheel speed sensors 19 detect rotational speeds of individual wheels and feed detection signals to the ECU 10.

Both first pressure boosting linear valve 13FL and second pressure boosting linear valve 13RL regulate a high hydraulic pressure which is introduced via the main brake conduit A by being independently linear controlled by the ECU 10 and accumulated in the accumulator 6, thereby applying the hydraulic pressure to the first brake conduit B1 and the second brake conduit B2. The first and second pressure reducing linear valves 14FL and 14RL are independently linear controlled by the ECU 10, thereby controlling the hydraulic pressures in the first brake conduit B1 and the second brake conduit B2, respectively. Specifically, in a pressure increasing status of the hydraulic pressure in the first brake conduit B1, the ECU 10 linearly controls a valve opening of the first pressure boosting linear valve 13FL so as to obtain target braking force and changes its state into a regulated state, and closes the first pressure reducing linear valve 14FL and changes its state into a shut-off state. Further, in a pressure maintenance status of the hydraulic pressure in the first brake conduit B1, the ECU 10 closes the first pressure boosting linear valve 13FL and changes its state into a shut-off state. Moreover, in a pressure reducing status of the hydraulic pressure in the first brake conduit B1, the ECU 10 closes the first pressure boosting linear valve 13FL and changes its state into a shut-off state and linearly controls a valve opening of the first pressure reducing linear valve 14FL so as to obtain the target braking force and changes its state into a regulated state.

Accordingly, in the aforementioned pressure increasing, pressure maintenance and pressure reducing statuses, the hydraulic pressure in the first brake conduit B1 is feedback controlled by detection values from a pressure sensor 15FL. Then, the caliper 16FL of the left front wheel FL generates braking force corresponding to the thus controlled hydraulic pressure.

The linear control in the pressure increasing, pressure maintenance and pressure reducing statuses of the hydraulic pressure in the second brake conduit B2 executed by the second pressure boosting linear valve 13RL and the second pressure reducing linear valve RL are the same as the control for the first brake conduit B1 as described above, except that the second pressure reducing linear valve 14RL is closed and its state is changed into a communicated state. Therefore, an explanation on the control for the second brake conduit B2 thereof will be omitted.

The ECU 10 independently calculates the target braking force F1 and F2 to be generated in the left front wheel FL and the right front wheel FR, respectively, based on the depression amount of the brake pedal 1, wheel speeds for individual wheels and the like, that are obtained from outputs from the various sensors. Further, the ECU 10 calculates the first hydraulic pressure and the second hydraulic pressure, which are in proportion each other, to be applied to the first brake conduit B1 and the second brake conduit B2, respectively. Next, the ECU 10 uses these calculated values as target values and feed-back controls detection values from the pressure sensors 15FL and 15RL.

In the normal pressure increase, pressure retaining, and pressure reducing strokes, when normal braking is applied, the operational pattern of the above described first and second pressure boosting linear valves 13FL and 13RL, and the first and second pressure reducing linear valves 14FL and 14RL in the left front wheel FL and the left rear wheel RL is executed by the ECU 10. Also, the operation pattern in the first and second pressure boosting linear valves 13FR and 13RR and the first and second pressure reducing linear valves 14FR and 14RR in the front and rear wheels FR and RR on the right side is executed in a similar manner.

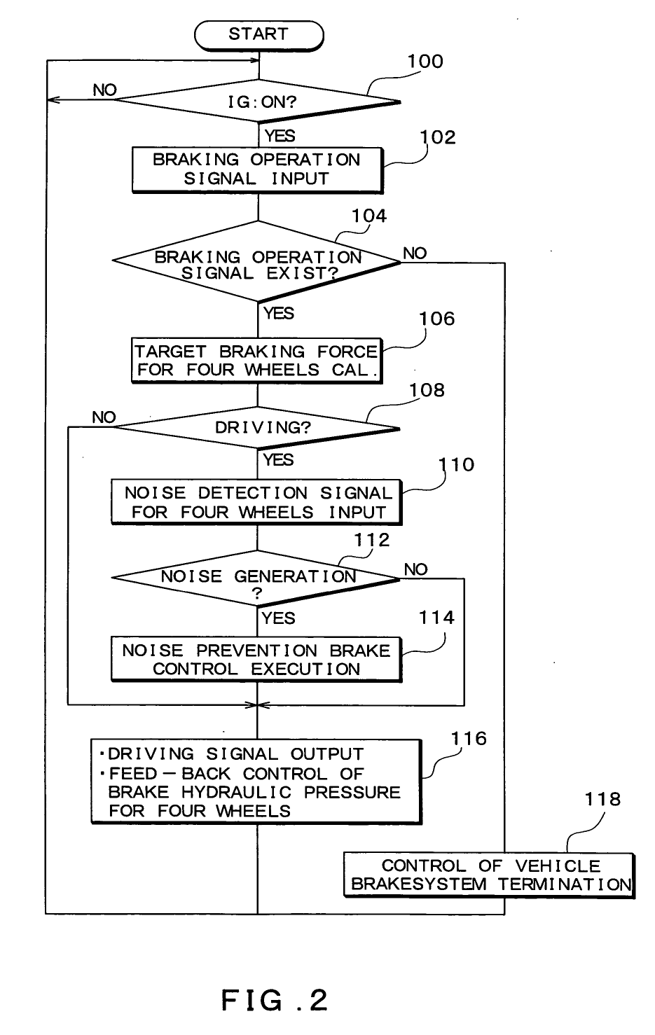

Next, an explanation will be given on a noise prevention brake control in the first embodiment when a brake noise is generated. FIG. 2 is a flow chart showing the procedure contents of the main routine of the brake control executed by the ECU 10.

At 100 of the procedure, the ECU 10 monitors whether an ignition switch has been turned ON or not. When the ignition is ON, the ECU 10 inputs a braking operation signal at 102 of the procedure, such as a detection signal from a stroke sensor 2 which detects a condition where the brake pedal 1 is depressed.

When the ECU 10 determines that there is no braking operation signal at 104 of the procedure, the procedure proceeds to processing at 118 where the control of the vehicle brake system ends and the procedure returns to the start. When the ECU 10 determines that there is a braking operation signal, the procedure proceeds to processing at 106 where the target braking force F1, F2, F3 and F4 for the four individual wheels FL, RL, FR and RR is calculated based on various sensor signals.

Next, at 108 of the procedure, the ECU 10 determines whether the vehicle is driving or not based on an output signal of each of the wheel speed sensors 19. When the ECU 10 determines that the vehicle is not driving, the procedure proceeds to processing at 116 assuming that the brake noise is not generated. When the ECU 10 determined that the vehicle is driving, noise detection signals, that is, detection signals from individual vibration sensors 18 are input, and the ECU 10 determines whether the noise is generated in at least one of the wheels based on the detection signals from individual vibration sensors 18 at 112. Specifically, the ECU 10 determines that the brake noise is generated in a wheel based on whether the detection signals from the vibration sensors 18 contain frequency component which corresponds to the brake noise (such as approx. 1 kHz to 6 kHz).

If the determination result at 112 of the procedure is NO, the procedure proceeds to processing at 116, and if YES the procedure proceeds to processing at 114 where the noise prevention brake control is executed.

At 116 of the procedure, the ECU 10 executes the feed-back control of the brake hydraulic pressure so as to generate the first to fourth hydraulic pressures in the vehicle brake system. This execution aims to realize the target braking force F1, F2, F3 and F4 which was calculated for the individual wheels.

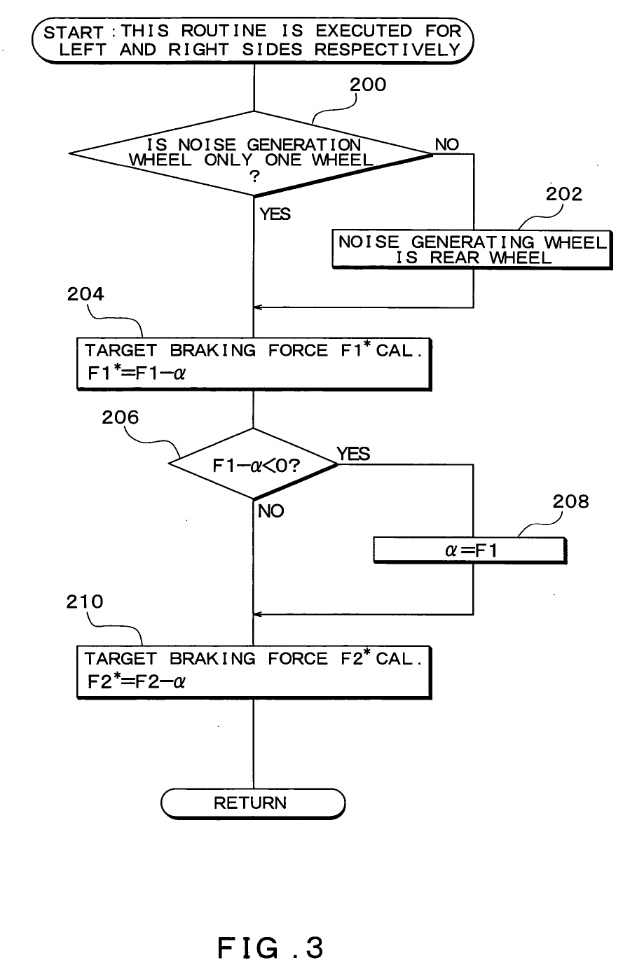

FIG. 3 is a flow chart showing a routine of a noise prevention brake control which is executed at 114. Note that an explanation will be given hereafter on the procedure contents for the front and rear wheels FL and RL on the left side. The same procedure will be also executed for the front and rear wheels FR and RR on the right side at the same time when the procedure is executed for the front and rear wheels FL and RL on the left side.

At 200 of the procedure, the ECU 10 determines whether or not a brake noise is detected from only one of the left front wheel FL and the left rear wheel RL based on various detection signals. If the determination result is YES, the wheel where the noise is generated is determined as a noise generating wheel, and the procedure proceeds to processing at 204. If the determination result is NO, in other words, if the noise is generated both in the left front wheel FL and the left rear wheel RL, the left rear wheel RL is determined as the noise generating wheel at 202 of the procedure.

At 204 of the procedure, the ECU 10 calculates target braking force for the noise generating wheel (herein expressed as F1) based on Equation 1.

F1*=F1−α Equation 1

Where, F1 is initial target braking force, and F1* is target braking force in the noise prevention brake control. Further, a predetermined amount α is a certain amount of braking force which has been predetermined required for reducing or suppressing the brake noise by changing a resonance mode of friction members in respective wheels. The predetermined amount α can take a positive or negative value. In the present first embodiment, the amount is set to be α>0, and thus the initial target braking force for the noise generating wheel is reduced.

At 206 of the procedure, the ECU 10 determines whether the target braking force F1* is a negative value or not. If F1* is a negative value, the target braking force is unrealizable. Therefore, the calculated target braking force F1* is set to be zero, that is, the predetermined amount α is set to be the same amount as the initial braking force F1. If the value is not a negative value, the procedure proceeds to processing at 210.

At 210 of the procedure, the ECU 10 calculates the target braking force F2* for the wheel, out of the left front wheel and the left rear wheel, other than the noise generating wheel based on Equation 2. The procedure returns to the main routine.

F2*=F2+α Equation 2

That is, the target braking force for the wheel other than the noise generating wheel is increased by the amount equal to the amount of decrease α of the target braking force for the noise generating wheel.

As described above, in the present first embodiment, in the set of the left front wheel FL and the left rear wheel RL and in the set of the right front wheel FR and the right rear wheel RR, respectively, the wheel where the brake noise is detected is determined as the noise generating wheel. The target braking force for the noise generating wheel is reduced by the predetermined amount α, and at the same time, the target braking force for the other wheel is increased by the same amount α, thereby making the total braking force of the front and rear wheels constant.

Accordingly, it is possible to reduce or suppress the brake noise in the wheel where the brake noise is detected. Further, since braking force is controlled independently for each of the left and right, and front and rear wheels, deviation from the optimal distribution of the braking force can be reduced to the minimum. Therefore, an abnormal vehicle behavior is prevented, and the driver does not feel an unpleasant sensation.

(Second Embodiment)

Next, a second embodiment will be explained. In the second embodiment, in a noise prevention brake control executed by the ECU 10, sets of two wheels that are located at diagonal positions are created, that is, a set of the left front wheel FL and the right rear wheel RR, and a set of the right front wheel FR and the left rear wheel RL are created. The brake noise is reduced or suppressed by reducing or increasing target braking force for the sets of diagonal wheels, whereby deviation from the optimal distribution of the braking force between the front and the rear of the vehicle.

Note that also in the second embodiment, the configuration of the vehicle brake system (FIG. 1) and the contents of the procedure of the main routine (FIG. 2) which is executed by the ECU 10 are the same as those in the first embodiment as described above. Therefore, the explanation thereof will be omitted.

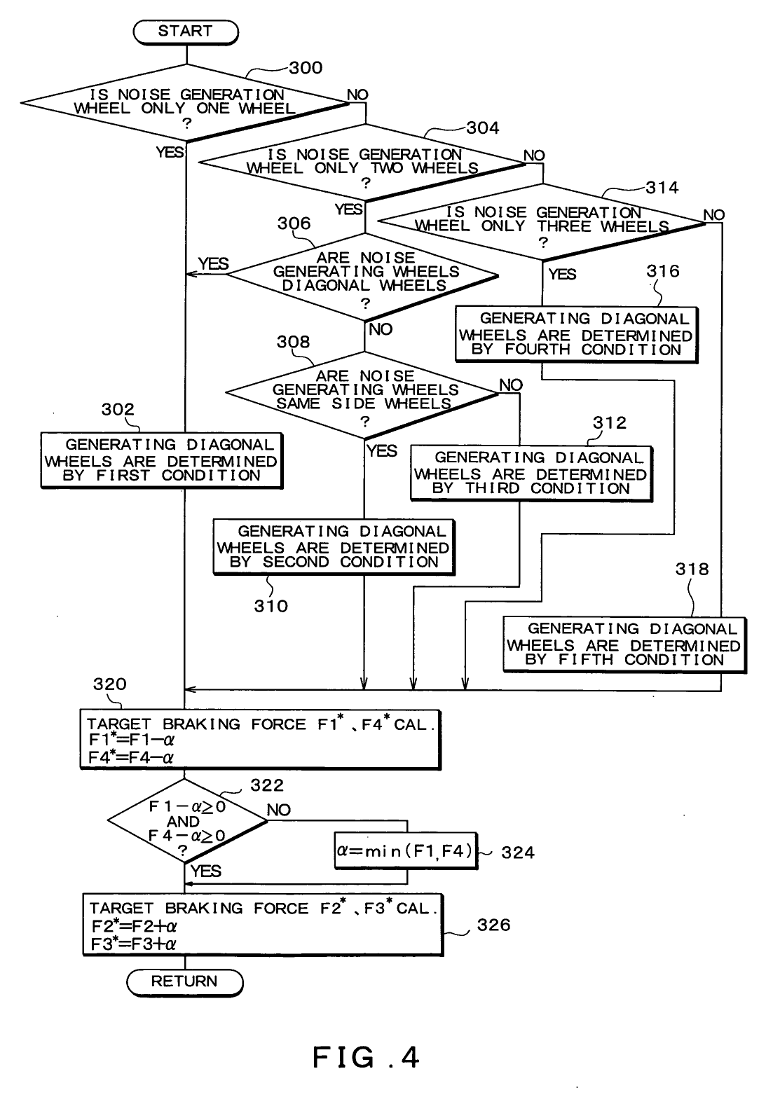

FIG. 4 is a flow chart showing the procedure of the noise prevention brake control in the second embodiment that is executed at 114 of the procedure in the main routine (FIG. 2). Hereafter, out of the two sets of diagonal wheels, a pair of diagonal wheels for which the target braking force should be reduced or suppressed for reducing or suppressing the brake noise are determined as generating diagonal wheels. Further, the left front and rear wheels and the right front and rear wheels are referred to as wheels on the same side, respectively.

At 300 of the procedure, whether or not the noise generating wheel where the brake noise is detected is only one wheel. If the result is YES, the procedure proceeds to processing at 302. At 302 of the procedure, the generating diagonal wheels are determined based on the first condition that a pair of diagonal wheels which include the noise generating wheel are determined as the generating diagonal wheels. Based on this first condition, it is possible to always set the wheel where the brake noise is generated as the generating diagonal wheels.

If the determination result at 300 is NO, it is determined whether or not the noise generating wheels are only two wheels at 304 of the procedure. If the determination result at 300 is YES, the procedure proceeds to processing at 306 where it is determined whether or not the two noise generating wheels are a pair of diagonal wheels. If the determination result at 306 is YES the procedure proceeds to processing at 302, and if the determination result at 306 is NO the procedure proceeds to processing at 308, where it is determined whether or not the noise generating wheels are wheels on the same side.

If the determination result at 308 is YES, the brake noise is generated either on the left front and rear wheels or on the right front and rear wheels. Therefore, at the next 310 of the procedure, the generating diagonal wheels are determined based on the second condition that a pair of diagonal wheels the front wheel of which is the noise generating wheel are determined as the generating diagonal wheels. Generally, since a front wheel is provided with larger braking force than a rear wheel, a vibration caused by the brake noise is larger in the front wheel. Moreover, the driver feels the brake noise in the front wheels stronger than that in the rear wheels. Therefore, based on the second condition, it is possible to set a front wheel where the vibration caused by the brake noise is larger, or it is felt strongly by the driver as the generating diagonal wheels.

If the determination result at 308 is NO, the brake noise is generated in the two wheels in either one of the set of the left and right front wheels or the set of the left and right rear wheels. Therefore, at next 312 of the procedure, the generating diagonal wheels are determined based on a third condition that a pair of diagonal wheels which contain a generating wheel which generates a larger brake noise are determined as the generating diagonal wheels. Based on the third condition, it is possible to set the generating diagonal wheels, so that the generating diagonal wheels always include a wheel which has a larger vibration caused by the brake noise.

Further, if the determination result at 304 is NO, it is determined that whether there are three noise generating wheels at 314. If the result at 304 is YES, the generating diagonal wheels are determined at 316, based on a fourth condition that a pair of diagonal wheels where a noise is detected in both of the diagonally positioned two wheels are determined as the generating diagonal wheels.

Further, if the determination result at 314 is NO, the generating diagonal wheels are determined at 318, based on a fifth condition that a pair of diagonal wheels which include the wheel where the most remarkable brake noise is generated are determined as the generating diagonal wheels.

After the generating diagonal wheels are determined in the manner as described above, next at 320, the target braking force F1* and the target braking force F4* for respective wheels that constitute the set of generating diagonal wheels are calculated by subtracting the predetermined amount α from the initial target braking force F1 and the initial target braking force F4, respectively, as shown in Equations 3 and 4.

F1*=F1−α Equation 3

F4*=F4−α Equation 4

Next, at 322 of the procedure, it is determined whether neither of the calculated target braking force F1* or F4* takes a negative value, that is, whether both F1* and F4* equal to or greater than zero or not. If the result is YES, the procedure proceeds to processing at 326. If the result is NO, at least one of the calculated target braking force F1* and F4* is a negative value which is unrealizable. Therefore, at 324 of the procedure, a smaller value of the initial target braking force F1 and the initial target braking force F4 is set to the predetermined amount α based on Equation 5, so that both target braking force are zero or greater, then the procedure proceeds to processing at 326.

α=min {F1, F4} Equation 5

At 326 of the procedure, the target braking force F2* and the target braking force F3* for each of the set of diagonal wheels that are not selected as the generating diagonal wheels (hereafter, referred to as non-generating diagonal wheels) are calculated by adding the predetermined amount α to the initial target braking force F2 and the initial target braking force F3, as shown in Equations 6 and 7, respectively. Then, the procedure returns to the main routine.

F2*=F2+α Equation 6

F3*=F3+α Equation 7

As described above, in the present second embodiment, a pair of diagonal wheels which include a wheel where the brake noise is detected are selected as the generating diagonal wheels. Then each braking force for both of the generating diagonal wheels is reduced by the predetermined amount α simultaneously, whereby the brake noise in each of the pair of diagonal wheels including the wheel where the brake noise is generated can be reduced, suppressed, or prevented.

Furthermore, the braking force is increased for the non-generating diagonal wheels which are not selected as the generating diagonal wheels by an amount α equivalent to the amount of decrease in the generating diagonal wheels. Accordingly, all of the total braking force for the left front and rear wheels, the total braking force for the right front and rear wheels, the total braking force for the left and right front wheels, and the total braking force for the left and right rear wheels remain unchanged. Therefore, an optimal distribution of the braking force between the front and the rear of the vehicle is maintained, and a change of the braking force in the left and right sides of the vehicle is eliminated. Accordingly, a brake noise can be reduced or suppressed and an abnormal vehicle behavior is eliminated, whereby the driver does not feel an unpleasant sensation.

Meanwhile, the left and right wheels on the same axle (that is, the left and right front wheels or the left and right rear wheels) are equally likely to generate a brake noise. Also as to these wheels on the same axle, a change in the braking force occurs in the opposite manner on the left side and the right side, thereby enabling a change in a vibration mode. Therefore, it is possible to prevent a brake noise in advance, even in the case where no brake noise is generated in the set of diagonal wheels other than the generating diagonal wheels.

Further, the generating diagonal wheels for which the target braking force should be reduced are selected, based on the first to five conditions, so that the generating diagonal wheels include a larger number of the wheels where the brake noise is generated, or include the wheel where the brake noise is most remarkable. Therefore, the effect of reducing or suppressing the brake noise is enhanced.

(Other Embodiments)

In the first embodiment described above, when selecting and determining the noise generating wheel in the case where the brake noise is detected in both front and rear wheels, the rear wheel is determined as the noise generating wheel at 202 of the procedure in FIG. 3. The present invention is not limited to this. That is, in the case where the brake noise is detected in both front and rear wheels on the left side and on the right side, respectively, the wheel with a remarkable generation state of the brake noise, that is, the wheel with a larger amplitude of the frequency component corresponding to the brake noise which is detected by the vibration sensor 18 may be determined as the noise generating wheel. Accordingly, it is possible to reduce the target braking force for the wheel where brake noise is remarkable, whereby the effect of reducing or suppressing the brake noise is enhanced.

Furthermore, in the second embodiment, the generating diagonal wheels are selected and determined based on the first to fifth conditions in accordance with the generation state of the brake noise. The present invention is not limited to this. For example, at 318 of the procedure in FIG. 4, the generating diagonal wheels may be determined based on, a sixth condition that a pair of diagonal wheels, out of the left front wheel FL and the right front wheel FR, which include a front wheel where the brake noise is larger (more remarkable) than the other front wheel are determined as the generating diagonal wheels, in place of the fifth condition. Accordingly, the brake noise is effectively reduced in the front wheels which contribute more greatly to the brake noise of the whole vehicle.

Moreover, in the second embodiment, regardless of the generation state of the brake noise, the generating diagonal wheels may be determined in all cases based on the fifth condition that a pair of diagonal wheels which include the wheel where the most remarkable noise is generated are determined as the generating diagonal wheels.

In each of the embodiments, the brake noise is detected by the vibration sensor 18 disposed in the caliper 16. The present invention is not limited to this. For example, generation of the brake noise or possibility of generation thereof may be detected based on whether rotational fluctuation of the wheel speed included in the detection signal by the wheel speed sensor 19 includes the frequency component corresponding to the brake noise.

While the above description is of the preferred embodiments of the present invention, it should be appreciated that the invention may be modified, altered, or varied without deviating from the scope and fair meaning of the following claims.

What is claimed is:

1. A vehicle brake system which sets target braking force for individual wheels and controls braking force for the individual wheels in accordance with the target braking force, the vehicle brake system comprising:
a noise detection unit which detects a generation state of a brake noise in the individual wheels; and
a control unit which selects, in accordance with the generation state of the brake noise of the individual wheels detected by the noise detection unit, one of the front and rear wheels where the brake noise is generated on the left side and on the right side as a noise generating wheel, reduces the target braking force for the noise generating wheel by a predetermined amount, and increases the target braking force for one of the front and rear wheels which is other than the noise generating wheel by the predetermined amount.

2. The vehicle brake system according to claim 1, wherein, when a generation of the brake noise is detected in both front and rear wheels, the control unit selects the rear wheel as the noise generating wheel.

3. The brake control system according to claim 1, wherein, when a generation of the brake noise is detected in both front and rear wheels, the control unit selects a wheel where the brake noise is most remarkable as the noise generating wheel.

4. A vehicle brake system which sets target braking force for individual wheels and controls braking force for the individual wheels in accordance with the target braking force, the vehicle brake system comprising:
a noise detection unit which detects a generation state of a brake noise in the individual wheels; and
a control unit which selects, in accordance with the generation state of the brake noise of the individual wheels detected by the noise detection unit, a pair of diagonal wheels which are diagonally located and which include a wheel where the brake noise is generated as generating diagonal wheels among the wheels of the vehicle, reduces the target braking force for each of the generating diagonal wheels by a predetermined amount, and increases the target braking force for each of the pair of diagonal wheels other than the generating diagonal wheels by the predetermined amount.

5. The vehicle brake system according to claim 4, wherein the control unit selects a pair of diagonal wheels which include a wheel where the detected brake noise is most remarkable as the generating diagonal wheels.

6. The vehicle brake system according to claim 4, wherein, when the brake noise is detected in both front and rear wheels on the same one of the left and right sides, the control unit selects a pair of diagonal wheels which include the front wheel where the noise is detected as the generating diagonal wheels.

7. The vehicle brake system according to claim 4, wherein, when the brake noise is detected in one of a pair of front wheels and a pair of rear wheels, the control unit selects a pair of diagonal wheels which include a wheel where the brake noise is most remarkable as the generating diagonal wheels.

8. The vehicle brake system according to claim 4, wherein, when the brake noise is detected in three wheels, the control unit selects a pair of diagonal wheels where a noise is detected in both of the diagonal wheels are determined as the generating diagonal wheels.
